(19) United States
(12) Patent Application Publication
(10) Pub. No.: US 2018/0124183 A1
(43) Pub. Date: May 3, 2018

(54) Method and Apparatus for Stateful Control of Forwarding Elements

(71) Applicant: Futurewei Technologies, Inc., Plano, TX (US)

(72) Inventors: Ulas Can Kozat, Mountain View, CA (US); Kaippallimalil Mathew John, Richardson, TX (US)

(21) Appl. No.: 15/342,962

(22) Filed: Nov. 3, 2016

(51) Int. Cl. H04L 29/08; H04L 12/24; H04W 28/08

(52) U.S. Cl. CPC H04L 67/125; H04L 41/046; H04W 28/08; H04L 41/20

(57) ABSTRACT

A method for controlling a network element by a remote controller comprising a processor coupled to a transmitter comprises modeling, by the processor, a state machine that controls transitions between operational states of the network element, offloading, by the transmitter, to the network element a portion of the state machine that controls a subset of the transitions, the subset comprising selected transitions that are more suitable for local control by the network element than remote control by the remote control application, and remotely controlling, by the processor, other transitions that are not in the subset of the transitions.

### TECHNICAL FIELD

The present invention relates generally to the field of software defined networks and network function virtualization and to stateful control of forwarding elements.

### BACKGROUND

A software defined network (SDN) decouples a control plane and a user plane of the network. Network function virtualization separates control plane and user plane functions from hardware. In addition, network function virtualization enables network functions to be deployed based on specific service needs, anywhere in a telecommunication cloud. Compared to legacy networks, a software defined network provides better scaling of the control plane and user plane, faster introduction of network functions, more dynamic network customization, and remote state collection and monitoring.

### SUMMARY

In accordance with an embodiment of the present invention, a method for controlling a network element by a remote controller comprising a processor coupled to a transmitter comprises modeling, by the processor, a state machine that controls transitions between operational states of the network element, offloading, by the transmitter, to the network element a portion of the state machine that controls a subset of the transitions, the subset comprising selected transitions that are more suitable for local control by the network element than remote control by the remote control application, and remotely controlling, by the processor, other transitions that are not in the subset of the transitions.

In accordance with another embodiment of the present invention, a remote controller comprises a transmitting component, a non-transitory memory storage comprising instructions, and one or more processors in communication with the transmitting component and the memory. The one or more processors execute the instructions to model a state machine that controls transitions between operational states of a network element. The transmitting component is configured to offload to the network element a portion of the state machine that controls a subset of the transitions, the subset comprising selected transitions that are more suitable for local control by the network element than remote control by the remote controller. The one or more processors are configured to remotely control other transitions that are not in the subset of the transitions.

In accordance with another embodiment of the present invention, a system for stateful control of a network element comprises the network element and a remote controller. The remote controller is configured to model a state machine that controls transitions between operational states of a network element, further configured to offload to the network element a portion of the state machine that controls a subset of the transitions, the subset comprising selected transitions that are more suitable for local control by the network element than remote control by the remote controller, and further configured to remotely control other transitions that are not in the subset of the transitions.

One or more embodiments provide for offloading of control decisions based on switch-local states to the switch side in a programmatic way from a remote controller. One or more embodiments provide a technique for implementing a policy-driven distributed control plane. The control logic may be moved closer to the transport resources in a programmable way to deliver high-speed control to achieve low latency and high throughput performance by avoiding bottlenecks due to the cloudification of the main control logic. A remote controller application still determines end-to-end policies, while policy enforcement is achieved at the local level. One or more embodiments are more versatile than the Policy and Charging Rules Function (PCRF)/Policy and Charging Enforcement Function (PCEF) approach in the Third Generation Partnership Project (3GPP) standards, as complex control plane decision logic may be programmed at any point in the network.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a network element onto which all control functions have been pushed;

FIG. 2 is a diagram of an embodiment apparatus for stateful network programming;

FIG. 3 is a diagram of an embodiment control flow for programming a network element with an event-condition-action rule;

FIG. 4 illustrates an embodiment event-condition-action table;

FIG. 5 is a diagram of an embodiment control flow for posting recipes to a programmable network element;

FIG. 6 illustrates an embodiment cookbook database containing posted recipes;

FIG. 7 is a diagram of an embodiment control flow for posting finite state machine rules;

FIG. 8 illustrates an embodiment finite state machine table containing posted finite state machine rules;

FIG. 9 is a diagram of an embodiment control flow based on monitored state changes;

FIG. 10 is a diagram of a step in an embodiment method for stateful control of a network element;

FIG. 11 is a diagram of another step in an embodiment method for stateful control of a network element;

FIG. 12 is a diagram of another step in an embodiment method for stateful control of a network element;

FIG. 13 is a diagram of another step in an embodiment method for stateful control of a network element;

FIG. 14 is a diagram of another step in an embodiment method for stateful control of a network element;

FIG. 15 illustrates a block diagram of an embodiment processing system for performing methods described herein; and

FIG. 16 illustrates a block diagram of a transceiver adapted to transmit and receive signaling over a telecommunications network.

### DETAILED DESCRIPTION OF ILLUSTRATIVE EMBODIMENTS

The structure, manufacture and use of the presently preferred embodiments are discussed in detail below. It should be appreciated, however, that the present invention provides many applicable inventive concepts that can be embodied in a wide variety of contexts. The embodiments discussed herein are merely illustrative of ways to make and/or use the invention, and do not limit the scope of the invention.

In mobile networks where the main workload is Internet-bound, some functions may be concentrated in a few central offices regardless of whether the functions provide session level, flow level, or packet level processing. Among the functions that may be concentrated in this manner are authentication, authorization and accounting (AAA), policy enforcement, quality of service (QoS) management, session control, Internet Protocol (IP) Multimedia Subsystem (IMS) access, public Internet access, deep packet inspection (DPI), and firewall functionality, for example. As workloads evolve and new use cases at the edge of the network emerge, this north-south traffic pattern may see a change in the form of east-west traffic (i.e., edge-to-edge communication services) and edge computing and storage. Centrally collecting all the session, UE, network, and traffic states and controlling the network elements based on these states in a closed-loop fashion may result in scaling problems and a decline in performance.

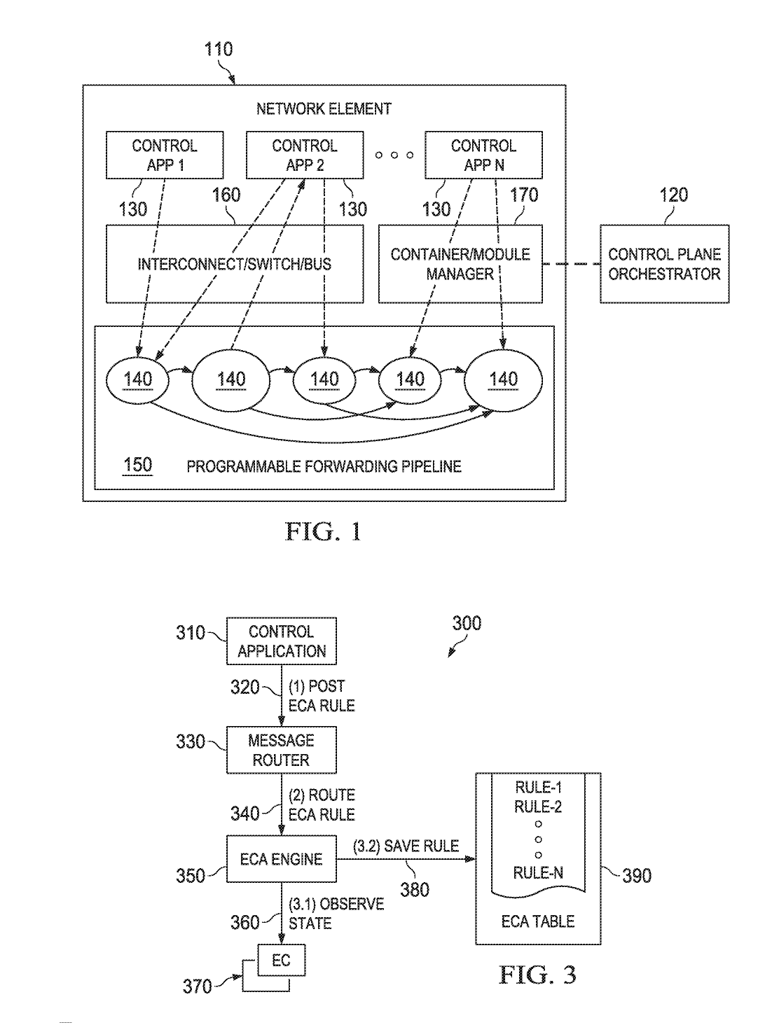

FIG. 1 illustrates a network element 110 onto which all control functions have been pushed from a control plane orchestrator 120. In particular, the control functions have been offloaded to a plurality of control applications 130 instantiated in the network element 110. Each of the control applications 130 may control one or more forwarding pipeline elements 140, which are part of a programmable forwarding pipeline 150. The control may be mediated by an interconnect switch/bus 160 and/or a container/module manager 170.

Several issues may arise when all control functions are offloaded to a network element 110 in the manner of FIG. 1. For example, the network element 110 may become bloated in such a case. Furthermore, if multiple control applications 130 act to program or configure the same forwarding module or pipeline 150, it may be unclear how to resolve conflicts. It may also be unclear how to isolate the policies of the control functions. In addition, there may be repetition across the control applications 130 regarding functions such as state maintenance and policy management. Moreover, it may be difficult to make dynamic changes in control functions. For instance, a complete new set of executable logic may need to be moved onto the network element 110 even when only a small number of statements or policies need to be changed. In addition to being inefficient, such a logic update may not be stateful.

In the next generation of networks, the needs of different workloads may need to be addressed in terms of latency and throughput while also satisfying the needs of operations support systems and business support systems (OSS/BSS) that may have a global network view to meet the end-to-end service requirements. A distributed and hierarchical control plane that can deploy control functions closer to the network elements that generate or aggregate the local states in a flexible and programmable way may address both performance needs as well as OSS/BSS needs. Embodiments disclosed herein provide solutions that enable such a distributed and hierarchical control plane.

In an embodiment, an apparatus and method are provided for running lightweight stateful control functions on network elements. The apparatus may consist of two tiers, where one tier comprises one or more remote control applications, and another tier comprises a network element (NE) with a control agent that hosts state machines for NE-local programmable entities, a cookbook of recipes, state machine tables, event-condition-action (ECA) tables, and corresponding engines to load, unload and execute actions specified by the tables. As used herein, the terms “network element” or “NE” may refer to a base station, a user equipment (UE), a switch, a gateway, or any similar component. A network element may also be referred to herein as a forwarding element.

The NE may be assumed to be remotely controllable. A remote control application capable of controlling an entity on an NE may first model the desired operational states of that entity and then push the resulting state machine onto the NE. Alternatively, a programmable entity may have a default state machine already hosted by the control agent on an NE. In the latter case, the remote control application may query a finite state machine (FSM) for the entity. Each controllable entity may be modeled as an FSM by the remote controller.

Once the state machine of a particular entity is stored on the NE, remote control applications can send instructions to the control agent on the NE to change the state of the entity from one state to another. Each state transition is accompanied by a series of locally executed control actions in a particular order. Such a collection of control actions executed in a particular order may be referred to as a recipe.

Currently, a plurality of instructions may be directly sent by control applications, but such a procedure may result in multiple round trips, the number of which may increase with the number of instructions that are to be completed sequentially. In the disclosed embodiments, on the other hand, a remote controller may program an entity on an NE in one high-level instruction. There may be a plurality of programmable entities on an NE or a plurality of instances for each programmable entity. Furthermore, each entity may consist of many states and state transitions. Thus, an NE may host multiple state machines and multiple recipes. A collection of recipes may be referred to as a cookbook for NE programmability. As described in more detail below, an NE may also host an ECA-based policy engine.

A remote control application (i.e., controller) may query the programmable entities on a particular NE. A remote controller may also push a policy by defining one or more events, one or more conditions, and one or more actions to be executed if the events occur and conditions hold. Actions may be in the form of executing a particular recipe or moving a controlled entity from one state to another. For example, the controller may push an instruction in the form “if event X occurs and condition Y is met, then execute recipe Z”. An event corresponds to changes in one or more monitored states on the NE (e.g., flow counters, flow buffers, or link up/down events). A condition statement may be one-dimensional (e.g., buffer A is empty) or multi-dimensional (e.g., served B bytes for flow F₁ and link Y is congested). A controller may push recipes before the ECA instruction is sent or at the same time the ECA instruction is sent. A controller may delete ECA rules, modify ECA rules, and update recipes. Embodiments allow a simple instruction or a state-transition instruction to be defined as an action rather than specifying a recipe. Embodiments also allow ECA rules to be executed once or repeatedly. The ECA-based approach allows controllers to react quickly to local state changes.

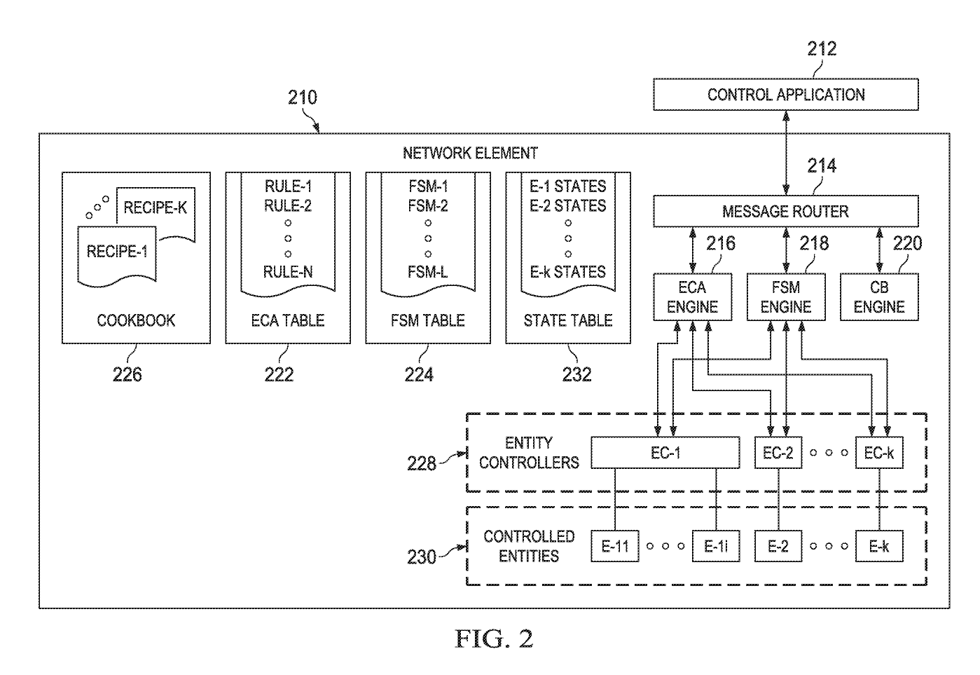

FIG. 2 illustrates internal components of an embodiment NE 210 that can communicate with a control application 212. The control application 212 or remote controller is a software defined network-based external entity that may be a discrete entity residing in a single component or may be an entity that is distributed across multiple components. The control application 212 programs the NE 210 by sending instructions to a message router 214 in the NE 210. The message router 214 forwards the instructions coming from the control application 212 to at least one of three engines, an ECA engine 216, an FSM engine 218, and a cookbook (CB) engine 220. Each of these engines has a corresponding table (i.e., ECA table 222, FSM table 224, and cookbook 226) to store policy rules, state transition rules, and a set of instructions to be executed in response to the state transition requests and observed events. The ECA engine 216 and the FSM engine 218 call local instructions on entity controllers 228 (e.g., EC-1 through EC-k), which in return program, control, and/or observe one or more controlled entities 230 (e.g., E-11 through E-1i, E2 to E-k). States of the controlled entities 230 may be stored in a state table 232.

The ECA engine 216 may receive a policy rule that specifies an event to be observed, monitored, or measured by the NE 210, a condition statement that is to be satisfied, and an action or a sequence of actions that are to be taken if the condition statement is satisfied when the event is observed. Events typically correspond to state changes of local virtual resources (e.g., a virtual port or container), physical resources (e.g., ternary content-addressable memory (TCAM) or interface cards), or logical resources (e.g., flow tables, packet counters, tunnels, or paths). An event may be a composite event, where the state changes of more than one resource change are observed, monitored, or measured. Similarly, a condition statement may be a composite statement, where more than one condition is to be satisfied.

In an embodiment, posting an ECA rule on an NE follows the steps in the flowchart 300 shown in FIG. 3. A control application 310 posts one or more ECA rules to an NE via a “post ECA rule” message 320 or similar message. A message router 330 is the receiving end of the NE for the ECA rules. The message router 330 forwards the ECA rules to an ECA engine 350 via a “route ECA rule” message 340 or similar message. The ECA engine 350 extracts the entities on the NE whose states are to be monitored and, via an “observe state” message 360 or similar message, instructs the corresponding entity controllers 370 to monitor the entities and pass state changes in the entities to the ECA engine 350. In an alternative embodiment, there may be a publish/subscribe subsystem or a message passing subsystem, where all events are broadcast by the entity controllers 3700. In such an embodiment, the ECA engine 350 may program its filters to listen to the events listed in the received ECA rules. The ECA engine 350 may save each received ECA rule into an ECA table 390 via a “save rule” message 380 or similar message.

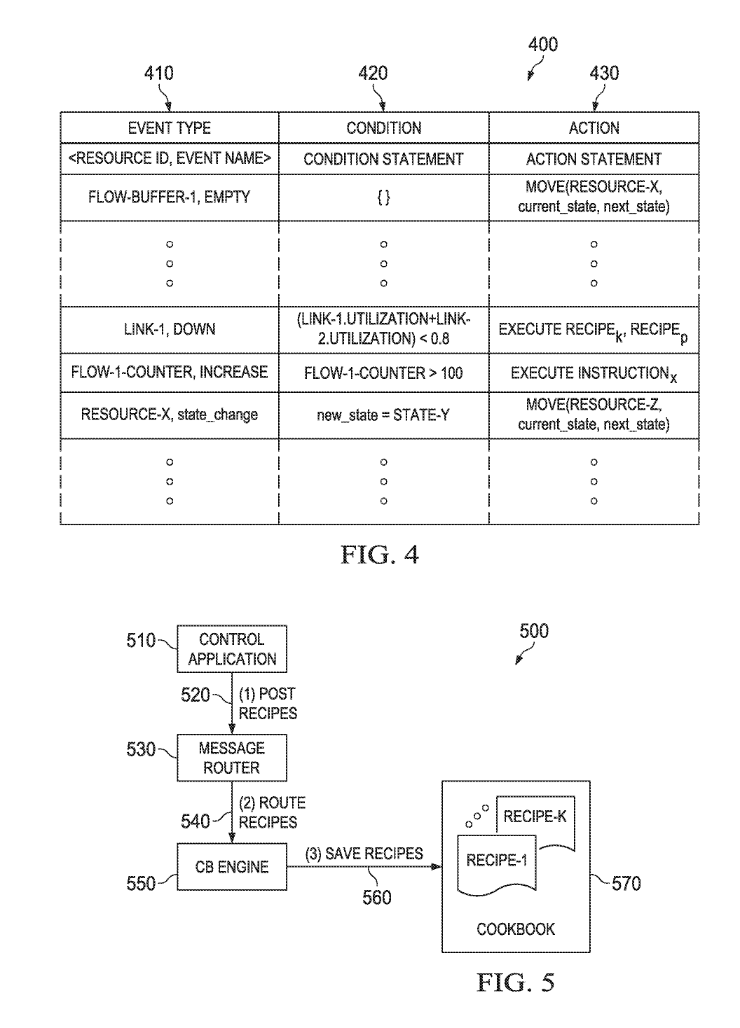

FIG. 4 illustrates an embodiment ECA table 400, where each row corresponds to one ECA rule. The ECA table 400 of FIG. 4 may be substantially similar to the ECA table 390 of FIG. 3. Items in a first column 410 specify an event type codified by a two-tuple <resource ID, event name>. Resource ID corresponds to a locally unique identifier for a local resource instance such as a particular interface, flow buffer, or flow table. Items in a second column 420 correspond to a condition statement, which may be null, a simple condition, or a composite condition. The condition statement may include arithmetic and logical operations on the observable properties or states of one or more resources. Items in a third column 430 correspond to action statements that may take one of three forms. In a first form, an action statement may be a generic “move” instruction or similar instruction that takes three parameters: a locally unique resource identifier, the current state, and the next state. In a second form, an action statement may be an “execute” statement or similar statement, where the parameters are provided as a list of recipes that are themselves a sequence of individual instructions that can be executed over locally controllable entities (e.g., flow tables, flow buffers, meters, counters, or ports). In a third form, an action statement may be a simpler “execute” statement that takes individual instructions as its parameters.

FIG. 5 illustrates an embodiment message sequence 500 for posting a recipe to a programmable NE. When a message router 530 receives a “post recipes” message 520 or similar message from a control application 510, the message router 530 forwards the received recipes as part of a “route recipes” message 540 or similar message to a cookbook engine 5500. The cookbook engine 550 locally stores the recipes in a cookbook database 570 via a “save recipes” message 560 or similar message.

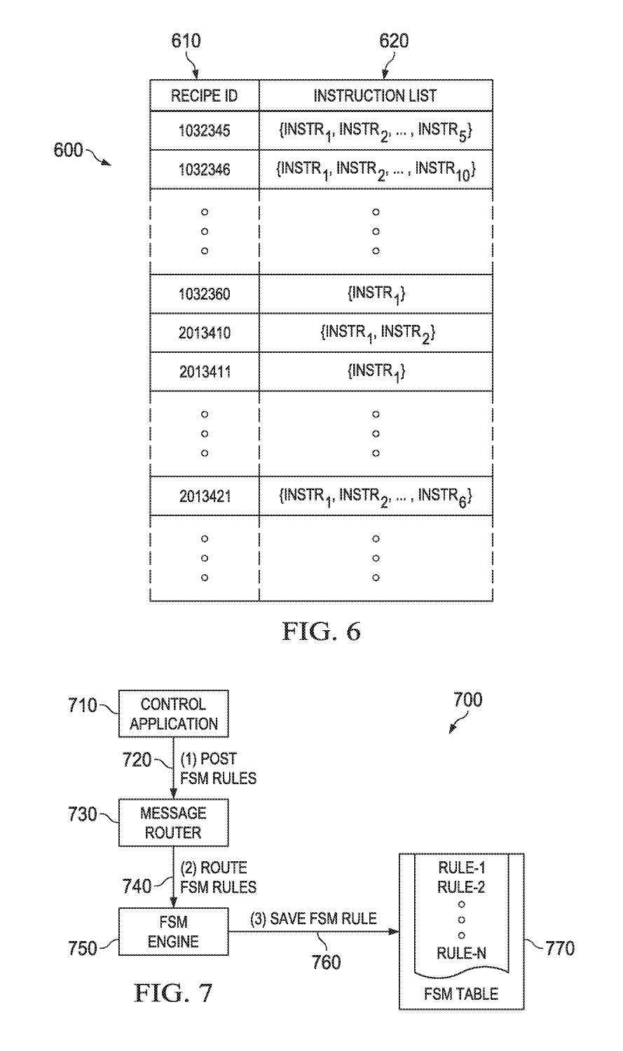

FIG. 6 illustrates an embodiment cookbook database 600, where each row is a unique recipe. The cookbook database 600 of FIG. 6 may be substantially similar to the cookbook database 570 of FIG. 5. Items in a first column 610 specify a locally unique recipe identifier. Items in a second column 620 specify a list of instructions that are associated with a recipe and that may be executed on specific controllable entities on an NE.

FIG. 7 illustrates an embodiment control flow 700 for posting an FSM rule. A message router 730 receives a set of FSM rules from a control application 710 via a “post FSM rules” message 720 or similar message. The message router 730 routes the rules to an FSM engine 750 via a “route FSM rules” message 740 or similar message. The FSM engine 750 saves the rules in an FSM table 770 via a “save FSM rules” message 760 or similar message. A FSM rule may specify a locally unique resource identifier, a first state that is matched against the current state of that resource, a second state that is matched against a target state of that resource, and a recipe identifier that points to a particular recipe to be executed to move the identified resource from the first state to the second state. For a FSM rule to be meaningful, a recipe with the specified recipe ID may need to be already stored in the cookbook.

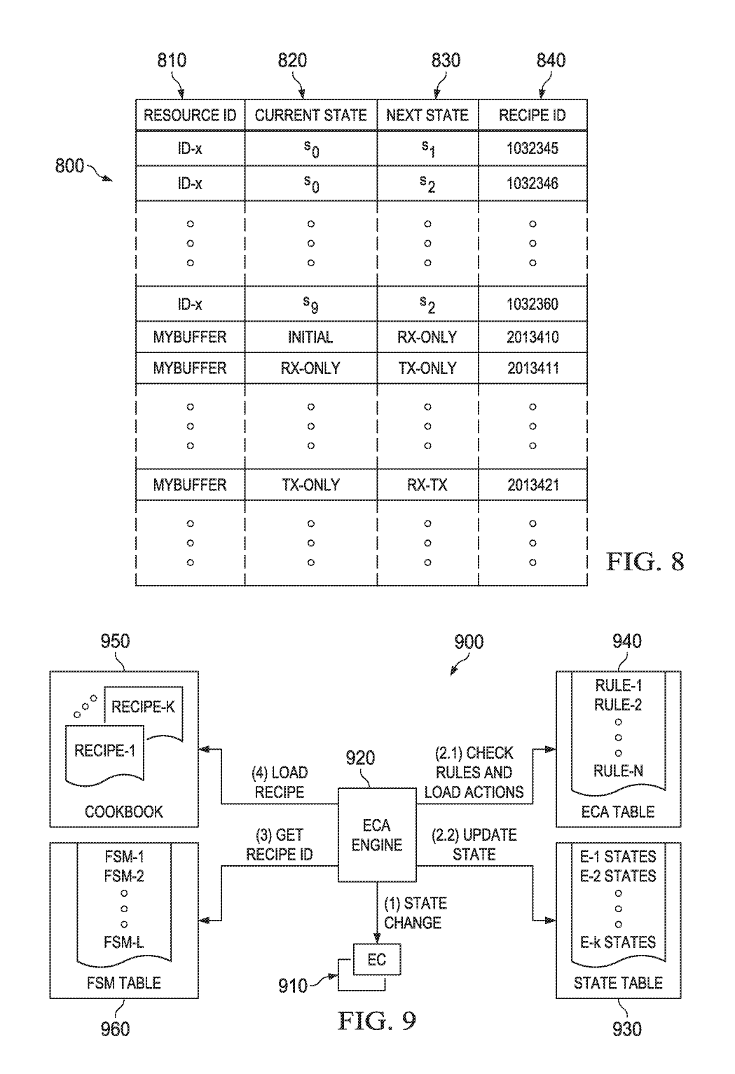

FIG. 8 illustrates an embodiment FSM table 800 comprising four columns. The FSM table 800 of FIG. 8 may be substantially similar to the FSM table 770 of FIG. 7. A first column 810 lists resource identifiers that are unique in the local scope of an NE. A resource identified by a resource identifier may be equivalent to one of the controlled entities 230 of FIG. 2, in some examples. The resource identifier may typically have a string type, but integer-based numbering or naming may be also used. A second column 820 is a current state column that lists the distinct states in which a resource may exist at the current time. All possible states need not be included in the current state column 820. That is, states not used for control purposes do not need to be included. A third column 830 is a next state column that lists the distinct states of a resource to which a remote control application may ask that resource to move. Again, not all possible states need to be included in the next state column 830 if the controller does not move a resource to some possible states. The states may typically have a string type, but may also have a numeral type. A fourth column 840 is a recipe ID column that identifies the recipe to be used for the state transition specified in a given row. The recipe ID may typically have a numeral type, but may also have a string type. The type convention may need to be consistent with the cookbook types.

Once the FSM rules, ECA rules, and recipes are stored in the FSM table, ECA table, and cookbook as disclosed herein, the ECA engine has the pieces in place to execute event and condition based actions. FIG. 9 illustrates an embodiment control flow goo for event and condition based actions. One or more entity controllers 910 observe state changes for their local controller entities. If a state change for a monitored entity is detected, the detecting entity controller 910 notifies an ECA engine 920. In an embodiment, the entity controllers 910 notify the ECA engine 920 of all the state changes of their controlled entities. In another embodiment, the ECA engine 920 subscribes for notifications of certain state transitions, and therefore an entity controller 910 notifies the ECA engine 920 only of subscribed events (i.e., state transitions). The ECA engine 920 keeps track of the monitored states by updating a state table 930. In an embodiment, the ECA engine 920 keeps only the last state of a controlled entity. In another embodiment, the ECA engine 920 keeps track of last Nᵢ states of the i-th controlled entity. Once the state of an observed entity is saved, the ECA engine 920 checks whether there is a related policy rule specified in an ECA table 9400. If a matching policy exists, the ECA engine 920 loads the additional conditions to be satisfied and the actions to be executed from the ECA table 9400. Using the state table 930, and possibly any other locally cached parameter values, the ECA engine 920 determines whether all the conditions are satisfied or not.

If all the conditions are satisfied, the ECA engine 920 may execute actions in one of several ways, depending on the type of action provided in the ECA rule. In a case of a simple set of instructions that are already stored as part of a policy rule, the ECA engine 920 executes the actions in the order in which the actions are listed in the rule. In a case where the actions are a list of recipes, the ECA engine 920 loads each recipe from a cookbook 950 in order, using recipe IDs, and executes each recipe in the order presented by the ECA rule. The recipe IDs may be retrieved from a FSM table 960. Each instruction in a recipe is executed in the order in which the instructions are listed in the recipe. In a case where the actions are “move” statements or similar statements (i.e., move a resource from a current state to a next state), the ECA engine 920 determines whether the current state of the resource matches the current state specified in the “move” instruction and, if so, loads the recipe IDs for each of the “move” instructions in the policy rule in the order in which the instructions are listed in the ECA rule. Each recipe is loaded from the cookbook 950 based on the recipe IDs, and the instructions within the loaded recipes are executed in the order in which the instructions are loaded from the cookbook 950. Actions specified in an ECA rule may belong to only one of the above categories or may be a combination of action types.

Similarly named components in FIGS. 2-9 may be substantially similar to one another even if the components are referred to by different reference numerals.

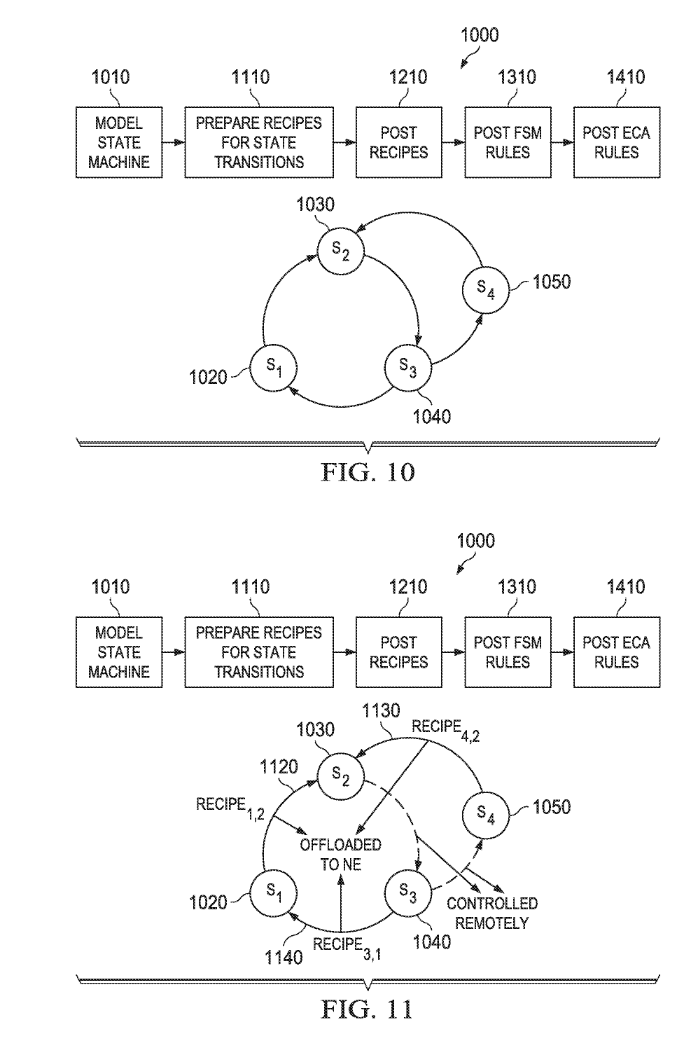

FIGS. 10-14 illustrate steps in an embodiment method 1000 for stateful control of a network element. The method 1000 includes a step 1010 in which a state machine is modeled, a step 1110 in which recipes for state transitions are prepared, a step 1210 in which recipes are posted, a step 1310 in which FSM rules are posted, and a step 1410 in which ECA rules are posted. Each step is described in more detail below. The steps do not necessarily need to be performed in the sequence shown, and some steps may be performed concurrently with other steps.

FIG. 10 illustrates a step 1010 in which a state machine is modeled. In this example, the model includes a transition from a first state 1020 to a second state 1030, a transition from the second state 1030 to a third state 1040, a transition from the third state 1040 to a fourth state 1050, a transition from the fourth state 1050 to the second state 1030, and a transition from the third state 1040 to the first state 1020.

FIG. 11 illustrates a step 1110 in which recipes for state transitions are prepared, where each recipe is a set of instructions that are called in sequence. In an embodiment, recipes are created only for transitions that are to be controlled locally on a network element. Recipes are not created for transitions that are to be controlled remotely by a remote controller. The remote controller or some other component may determine which transitions are more suitable for local control by the network element than remote control by the remote controller.

In the example of FIG. 11, the transition from the first state 1020 to the second state 1030, the transition from the fourth state 1050 to the second state 1030, and the transition from the third state 1040 to the first state 1020 are to be offloaded to a network element. Thus, a first recipe 1120 is prepared and includes instructions for transitioning from the first state 1020 to the second state 1030. A second recipe 1130 is prepared and includes instructions for transitioning from the fourth state 1050 to the second state 1030. A third recipe 1140 is prepared and includes instructions for transitioning from the third state 1040 to the first state 1020. The transition from the second state 1030 to the third state 1040 and the transition from the third state 1040 to the fourth state 1050 are to be controlled remotely by the remote controller, so recipes are not created for those transitions. In this way, a programmable network element may be partially controlled locally by recipes stored in the network element and partially controlled remotely by the remote controller.

Each state 1020-1050 in FIGS. 10 and 11 may have a corresponding row in an FSM table. The directional arrows showing from which current state to which next state a transition is occurring may correspond to one and only one recipe stored in a cookbook. In contrast, different state transitions may map to the same recipe ID and hence the same recipe. Different instances of the same resource type may share the same state machine, and no duplicate entries should exist in the FSM table. In contrast, different instances of the same resource type may utilize different recipes for their state transitions.

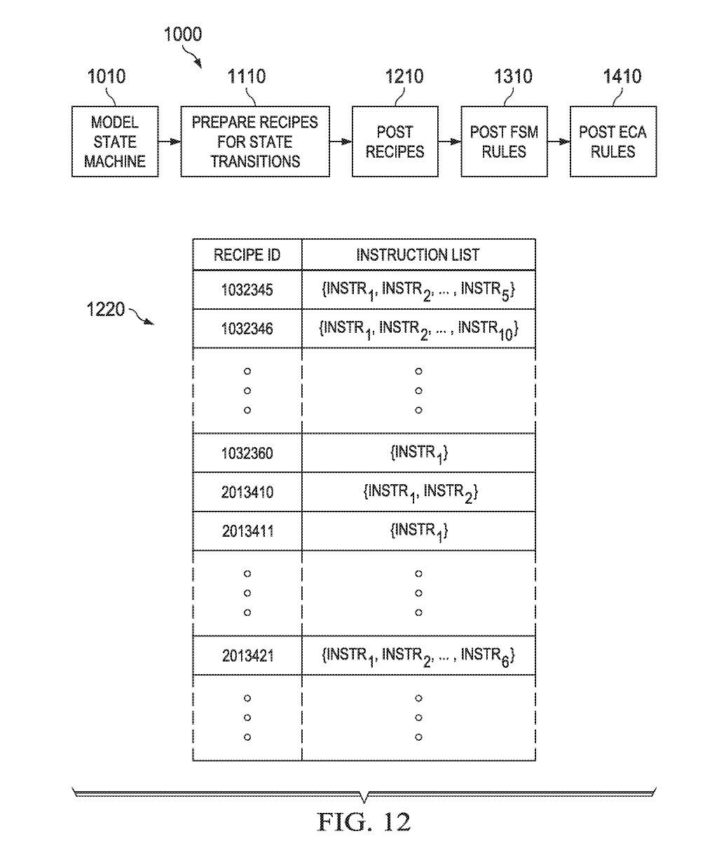

FIG. 12 illustrates a step 1210 in which recipes are posted. That is, the recipes that were prepared in FIG. 11 are stored in a table 1220 on the network element to which the recipes apply. The table 1220 may be substantially similar to the cookbook database 600 of FIG. 6.

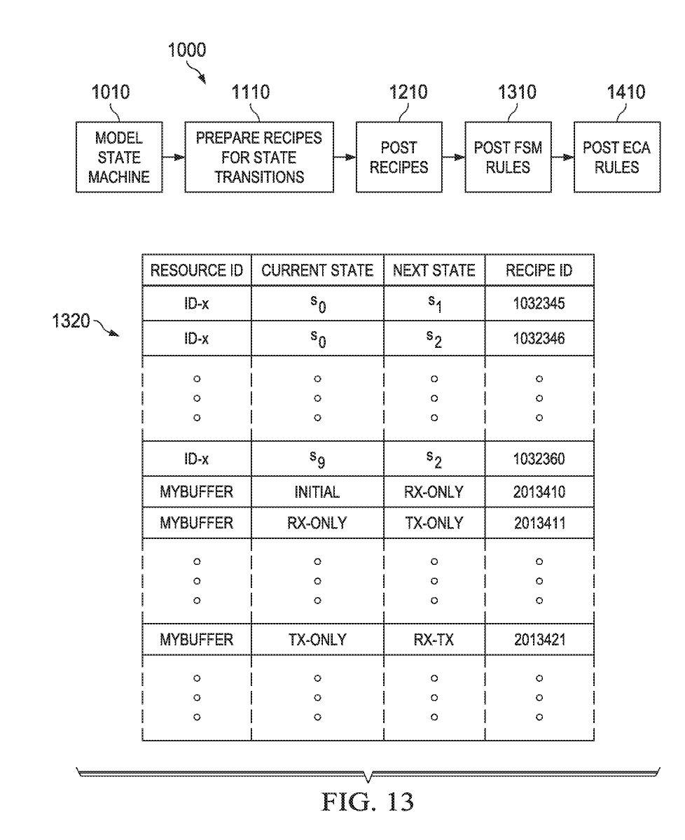

FIG. 13 illustrates a step 1310 in which FSM rules are posted. That is, as described above with regard to FIG. 7, one or more FSM rules are received and stored in an FSM table 1320. The FSM table 1320 may be substantially similar to the FSM table 800 of FIG. 8.

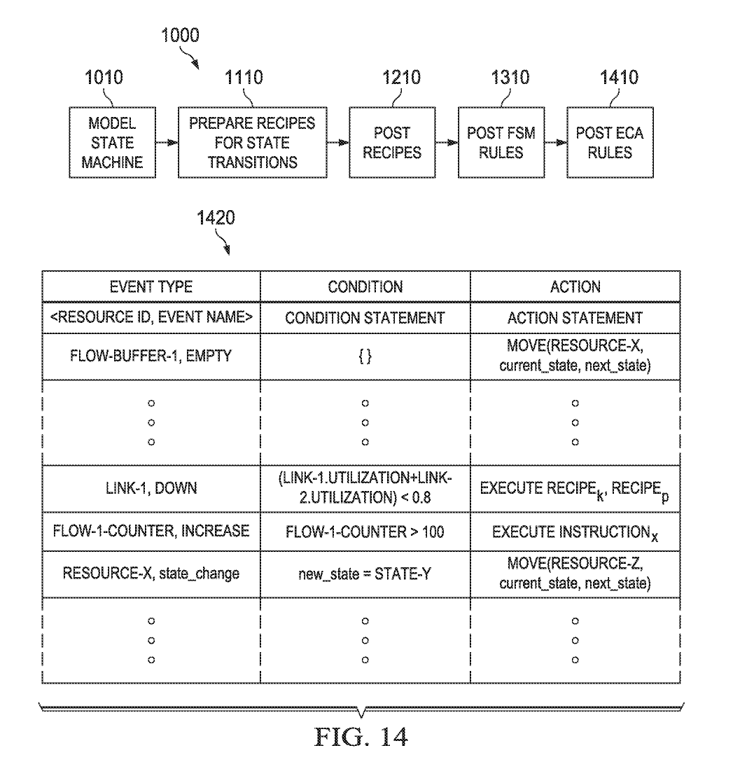

FIG. 14 illustrates a step 1410 in which ECA rules are posted. That is, as described above with regard to FIG. 3, one or more ECA rules are received and stored in an ECA table 1420. The ECA table 1420 may be substantially similar to the ECA table 400 of FIG. 4.

Offloading control plane functions onto network elements, as disclosed herein, may be done in various ways. In an embodiment, stateful data plane and control plane applications may be pushed to a forwarding element using a common execution environment (e.g., as bundles using an Open Service Gateway Initiative (OSGI) framework). A Berkeley Extensible Software Switch (BESS) or Vector Packet Processing (VPP) may also be used to insert stateful modules into the packet pipeline. All of these embodiments provide a capability of chaining functions such that an incoming packet may be selectively processed by the bundles. Control functions may be part of the chain and may be exposed as controlled entities bundled with entity controllers. Such an implementation may have a limited application, as such functions are driven by incoming flow packets. There may be states on the network element that are not altered due to data plane traffic flows, such as link up/down events or control signals.

A similar functionality may be gained by pushing actual codes to run in the control fabric of the network element (e.g., as containers). A remote controller may load or unload the codes onto the network element to change the control plane (as opposed to loading or unloading modules onto the packet processing pipeline). Such an embodiment may be more difficult to manage with respect to global management objectives, as each function may maintain its own finite state machine that is not exposed across functions. For instance, if two functions receive the same event as a trigger and perform local control actions based on the trigger, race conditions may result. Conversely, two functions that receive different event triggers may try to program the forwarding pipeline in an inconsistent manner. Rather than devising a policy conflict mechanism on the network element to manage such issues, it may be preferable to have a remote network controller detect and avoid such conflicts as well as to program each network element with consistent policies. The disclosed embodiments provide a straightforward way of achieving these objectives, as the embodiments allow the remote controller to explicitly program the policy rules and FSM rules. The disclosed embodiments are also suitable for dynamic programming, as updating the policy rules is faster than updating the binary codes.

One or more embodiments allow execution of control plane instructions, such as changing the flow rules, reading a flow meter, or changing the flow priority. In one or more embodiments, the remote control plane is offloaded onto the control plane of a network element. Furthermore, in one or more embodiments, the FSM is not driven only by the data plane packets but by virtually any observable state on the network element. The disclosed instruction sets that are based on moving a resource from one state to another using locally stored recipes are absent from existing systems.

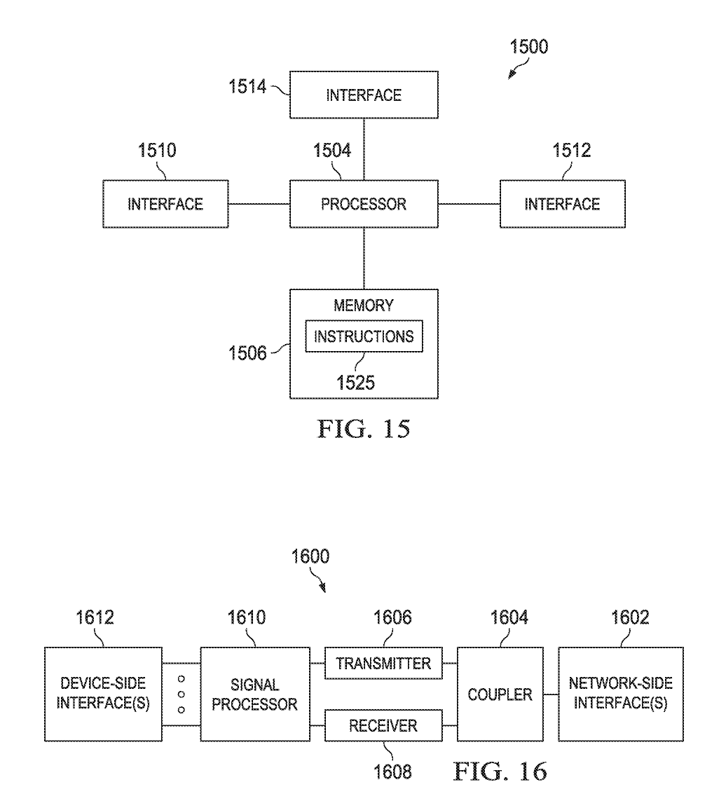

FIG. 15 illustrates a block diagram of an embodiment processing system 1500 for performing methods described herein, which may be installed in a host device. As shown, the processing system 150000 includes a processor 1504, a memory 1506, and interfaces 1510-1514, which may (or may not) be arranged as shown the figure. The processor 1504 may be any component or collection of components adapted to perform computations and/or other processing related tasks, and the memory 1506 may be any component or collection of components adapted to store programming and/or instructions for execution by the processor 1504. In an embodiment, the memory 1506 includes a non-transitory computer readable medium that stores instructions 1525. The instructions 1525 can be executed by the processor 1504. The interfaces 1510, 1512, 1514 may be any component or collection of components that allow the processing system 1500 to communicate with other devices/components and/or a user. For example, one or more of the interfaces 1510, 1512, 1514 may be adapted to communicate data, control, or management messages from the processor 1504 to applications installed on the host device and/or a remote device. As another example, one or more of the interfaces 1510, 1512, 1514 may be adapted to allow a user or user device (e.g., personal computer (PC), etc.) to interact/communicate with the processing system 1500. The processing system 1500 may include additional components not depicted in the figure, such as long term storage (e.g., non-volatile memory, etc.).

In some embodiments, the processing system 1500 is included in a network device that is accessing, or part otherwise of, a telecommunications network. In one example, the processing system 1500 is in a network-side device in a wireless or wireline telecommunications network, such as a base station, a relay station, a scheduler, a controller, a gateway, a router, an applications server, or any other device in the telecommunications network. In other embodiments, the processing system 150000 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1510, 1512, 1514 connects the processing system 1500 to a transceiver adapted to transmit and receive signaling over the telecommunications network. FIG. 16 illustrates a block diagram of a transceiver 1600 adapted to transmit and receive signaling over a telecommunications network. The transceiver 160000 may be installed in a host device. As shown, the transceiver 1600 comprises a network-side interface 1602, a coupler 1604, a transmitter 1606, a receiver 1608, a signal processor 1610, and a device-side interface 1612. The network-side interface 1602 may include any component or collection of components adapted to transmit or receive signaling over a wireless or wireline telecommunications network. The coupler 1604 may include any component or collection of components adapted to facilitate bi-directional communication over the network-side interface 1602. The transmitter 1606 may include any component or collection of components (e.g., up-converter, power amplifier, etc.) adapted to convert a baseband signal into a modulated carrier signal suitable for transmission over the network-side interface 1602. The receiver 1608 may include any component or collection of components (e.g., down-converter, low noise amplifier, etc.) adapted to convert a carrier signal received over the network-side interface 1602 into a baseband signal. The signal processor 1610 may include any component or collection of components adapted to convert a baseband signal into a data signal suitable for communication over the device-side interface(s) 1612, or vice-versa. The device-side interface(s) 1612 may include any component or collection of components adapted to communicate data-signals between the signal processor 11100 and components within the host device (e.g., the processing system 1500, local area network (LAN) ports, etc.).

In some embodiments, the processing system 1500 models a state machine that controls transitions between operational states of the network element, offloads to the network element a portion of the state machine that controls a subset of the transitions, the subset comprising selected transitions that are more suitable for local control by the network element than remote control by the remote control application, and remotely controls other transitions that are not in the subset of the transitions.

The transceiver 1600 may transmit and receive signaling over any type of communications medium. In some embodiments, the transceiver 1600 transmits and receives signaling over a wireless medium. For example, the transceiver 1600 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1602 comprises one or more antenna/radiating elements. For example, the network-side interface 1602 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1600 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a modeling unit/module, an offloading unit/module, a controlling unit/module and/or a preparing unit/module. The respective units/modules may be hardware, software, or a combination thereof. For instance, one or more of the units/modules may be an integrated circuit, such as field programmable gate arrays (FPGAs) or application-specific integrated circuits (ASICs).

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for controlling a network element by a remote controller comprising a processor coupled to a transmitter, the method comprising:
modeling, by the processor, a state machine that controls transitions between operational states of the network element;
offloading, by the transmitter, to the network element a portion of the state machine that controls a subset of the transitions, the subset comprising selected transitions that are more suitable for local control by the network element than remote control by the remote control application; and
remotely controlling, by the processor, other transitions that are not in the subset of the transitions.

2. The method of claim 1, further comprising:
preparing at least one recipe comprising a plurality of actions to be taken in a specified order to perform one of the transitions in the subset of the transitions; and
transmitting the at least one recipe to the network element.

3. The method of claim 2, further comprising transmitting to the network element, responsive to determining a reason for the network element to perform the one of the transitions in the subset of the transitions, an instruction to perform the actions in a recipe associated with the one of the transitions in the subset of the transitions.

4. The method of claim 3, further comprising transmitting to the network element at least one event-condition-action (ECA) rule and at least one finite state machine (FSM) rule for use by the network element in performing the actions in the recipe associated with the one of the transitions in the subset of the transitions.

5. A remote controller comprising:
a transmitting component;
a non-transitory memory storage comprising instructions; and
one or more processors in communication with the transmitting component and the memory, wherein the one or more processors execute the instructions to model a state machine that controls transitions between operational states of a network element, wherein the transmitting component is configured to offload to the network element a portion of the state machine that controls a subset of the transitions, the subset comprising selected transitions that are more suitable for local control by the network element than remote control by the remote controller, and wherein the one or more processors are configured to remotely control other transitions that are not in the subset of the transitions.

6. The remote controller of claim 5, wherein the remote controller prepares at least one recipe comprising a plurality of actions to be taken in a specified order to perform one of the transitions in the subset of the transitions and transmits the at least one recipe to the network element.

7. The remote controller of claim 6, wherein, responsive to determining a reason for the network element to perform the one of the transitions in the subset of the transitions, the remote controller transmits to the network element an instruction to perform the actions in a recipe associated with the one of the transitions in the subset of the transitions.

8. The remote controller of claim 7, wherein the remote controller transmits to the network element at least one event-condition-action (ECA) rule and at least one finite state machine (FSM) rule for use by the network element in performing the actions in the recipe associated with the one of the transitions in the subset of the transitions.

9. A system for stateful control of a network element, the system comprising:
the network element; and
a remote controller configured to model a state machine that controls transitions between operational states of a network element, further configured to offload to the network element a portion of the state machine that controls a subset of the transitions, the subset comprising selected transitions that are more suitable for local control by the network element than remote control by the remote controller, and further configured to remotely control other transitions that are not in the subset of the transitions.

10. The system of claim 9, wherein the remote controller is further configured to prepare at least one recipe comprising a plurality of actions to be taken in a specified order to perform one of the transitions in the subset of the transitions and further configured to transmit the at least one recipe to the network element.

11. The system of claim 10, wherein, responsive to determining a reason for the network element to perform the one of the transitions in the subset of the transitions, the remote controller is further configured to transmit to the network element an instruction to perform the actions in a recipe associated with the one of the transitions in the subset of the transitions.

12. The system of claim 11, wherein the network element comprises a message router configured to receive the recipe associated with the one of the transitions in the subset of the transitions, and to receive at least one event-condition-action (ECA) rule and at least one finite state machine (FSM) rule from the remote controller.

13. The system of claim 12, wherein the at least one ECA rule comprises an event type, a condition, and an action to be taken when the event type and condition are currently applicable.

14. The system of claim 12, wherein the at least one FSM rule comprises an identifier for a resource in the network element, a first state that is matched against a current state of the resource, a second state that is matched against a target state of the resource, and an identifier for a recipe for moving the resource from the first state to the second state.

15. The system of claim 12, wherein the message router is further configured to transmit the received recipe to a cookbook engine for storage in a cookbook table in the network element, further configured to transmit the at least one ECA rule to an ECA engine for storage in an ECA table in the network element, and further configured to transmit the at least one FSM rule to a FSM engine for storage in a FSM table in the network element.

16. The system of claim 15, wherein the ECA engine determines an entity on the network element whose state is to be monitored and instructs a controller of the entity to monitor the entity and to inform the ECA engine of a change in the entity.

17. The system of claim 16, wherein the ECA engine instructs the controller of the entity to inform the ECA engine of all changes in the entity.

18. The system of claim 16, wherein the ECA engine instructs the controller of the entity to inform the ECA engine of changes in the entity for which the ECA engine has subscribed to be notified.

19. The system of claim 16, wherein the ECA engine, responsive to being informed of a change in the entity, updates a state table with information regarding the change and determines whether a rule related to the change exists in the ECA table.

20. The system of claim 19, wherein, when a rule related to the change exists in the ECA table, the ECA engine determines whether a condition associated with the rule is satisfied, and when a condition associated with the rule is satisfied, the ECA engine retrieves from the FSM table an identifier for a recipe associated with the rule, retrieves from the cookbook table the recipe associated with identifier, and executes the actions specified in the recipe associated with identifier.
